(19) United States
(12) Patent Application Publication
(10) Pub. No.: US 2008/0208685 A1
(43) Pub. Date: Aug. 28, 2008

(54) ADVERTISEMENT PLANNING AND PAYMENT IN A VIRTUAL UNIVERSE (VU)

(76) Inventors: Rick A. Hamilton, Charlottesville, VA (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 11/679,715

(22) Filed: Feb. 27, 2007

(51) Int. Cl. G06Q 30/00

(52) U.S. Cl. 705/14

(57) ABSTRACT

the present invention provides an approach for planning and paying for advertisements in a VU. Specifically, under the present invention, it is first determined which sections of a region of the VU (referred to herein as “portions” or the VU), and which avatars are most viewed. This data is the analyzed to plan and place advertisements. Once advertisements are placed, users coupled be compensated based on the frequency, time, etc. that associated advertisements are viewed.

### FIELD OF THE INVENTION

The present invention generally relates to virtual universes (VUs). Specifically, the present invention relates to the planning and payment of advertisement(s) in a VU.

### BACKGROUND OF THE INVENTION

Virtual universes (VUs) are rapidly becoming a popular part of today's culture. In general, a VU is a digital world such as Second Life (Second Life is a trademark of Linden Research, Inc. in the United States and/or other countries), characterized by user(s) controlling avatar(s) representing the user(s) as they interact with each other and the environment within the VU. An avatar is a graphical representation the user selects that others can see, often taking the form of a cartoon-like human or other figure. An agent is the user's account, upon which the user can build an avatar, and which is tied to the inventory of assets the user owns. A region is a virtual area of land within the VU, typically residing on a server's CPU. Assets, avatar(s), the environment, and anything visual comprise universally unique identifiers (UUIDs) (tied to geometric data distributed to user(s) as textual coordinates), textures (distributed to user(s) as graphics files), and effects data (rendered by the user's client according to the user's preference(s) and user's device capabilities).

Second Life and other on-line virtual environments present a tremendous new outlet for both structured and unstructured virtual collaboration, gaming and exploration, as well as real-life simulations in virtual spaces. These activities, along with yet to be disclosed new dimensions, in turn provide a wide open arena for creative and new advertising methods and mechanisms. Whatever form the advertisements take, the challenge for advertisers is planning how and where to advertise, and how to compensate for advertisements, issues that no existing approach has been able resolve. In view of the foregoing, there exists a need for a solution that solves such problems.

### SUMMARY OF THE INVENTION

In general, the present invention provides an approach for planning and paying for advertisements in a VU. Specifically, under the present invention, it is first determined which sections of a region of the VU (referred to herein as “portions” or the VU), and which avatars are most viewed. This data is the analyzed to plan advertisements. Once advertisements are placed, users coupled be compensated based on the frequency, time, etc. that associated advertisements are viewed.

A first aspect of the present invention provides a method of planning and paying for advertisements in a virtual universe (VU), comprising: identifying portions of the VU and avatars in the VU that are most viewed; planning a placement of advertisements in the VU based on the identifying; and establishing a compensation plan based on a viewing of the advertisements.

A second aspect of the present invention provides a system of planning and paying for advertisements in a virtual universe (VU), comprising: a module for identifying portions of the VU and avatars in the VU that are most viewed; a module for planning a placement of advertisements in the VU based on the portions and the avatars; a module for placing the advertisements based o the placement; and a module for establishing a compensation plan based on a viewing of the advertisements.

A third aspect of the present invention provides a program product stored on a computer readable medium for planning and paying for advertisements in a virtual universe (VU), the computer readable medium comprising program code for causing a computer system to: identify portions of the VU and avatars in the VU that are most viewed; plan a placement of advertisements in the VU based on the portions and the avatars; and establish a compensation plan based on a viewing of the advertisements.

A fourth aspect of the present invention provides a method for deploying a system for planning and paying for advertisements in a virtual universe (VU), comprising: providing a computer infrastructure being operable to: identify portions of the VU and avatars in the VU that are most viewed; plan a placement of advertisements in the VU based on the portions and the avatars; and establish a compensation plan based on a viewing of the advertisements.

A fifth aspect of the present invention provides computer software embodied in a propagated signal for planning and paying for advertisements in a virtual universe (VU), the computer readable medium comprising program code for causing a computer system to: identify portions of the VU and avatars in the VU that are most viewed; plan a placement of advertisements in the VU based on the portions and the avatars; and establish a compensation plan based on a viewing of the advertisements.

A sixth aspect of the present invention provides a data processing system for planning and paying for advertisements in a virtual universe (VU), comprising: a memory medium having instructions; a bus coupled to the memory medium; and a processor coupled to the bus that when executing the instructions causes the data processing system to: identify portions of the VU and avatars in the VU that are most viewed; plan a placement of advertisements in the VU based on the portions and the avatars; and establish a compensation plan based on a viewing of the advertisements.

A seventh aspect of the present invention provides a computer-implemented method of planning and paying for advertisements in a virtual universe (VU), comprising: identifying portions of the VU and avatars in the VU that are most viewed; planning a placement of advertisements in the VU based on the identifying; and establishing a compensation plan based on a viewing of the advertisements.

Each of these aspects can also include one or more of the following additional aspects (in no particular order):

The identification of portions an avatars comprising tracking a quantity of texture renderings, a duration, and a distance that each portion and avatar in the VU is being viewed.

The planning of the placement comprising at least one of the following: identifying users corresponding to the most viewed avatars for proposed advertisement deals; identifying locations in the VU for placement of advertisements; and determining an appropriate size of the advertisements.

The compensation plan being based on at least one of the following: quantity of times each of the advertisements has been viewed; a duration that each of the advertisements has been viewed; a distance from which each of the advertisements has been viewed; and a quantity of users that have viewed each of the advertisements.

Advertisements are placed in the VU based on the planning/placement.

The placing comprising at least one of the following: associating advertisements with the most viewed avatars; and associating advertisements with the most viewed portions of the VU.

The compensation plan compensating at least one of the following: users whose avatars are associated with the advertisements; and users whose portions of the VU are associated with the advertisements.

The compensation plan comprising at least one of the following: a provision of credits associated with the VU; and a provision of compensation outside of the VU.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative computer system for implementing the teachings of the present invention.

FIG. 2 depicts an illustrative virtual environment according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides an approach for planning and paying for advertisements in a VU. Specifically, under the present invention, it is first determined which sections of a region of the VU (referred to herein as “portions” or the VU), and which avatars are most viewed. This data is the analyzed to plan advertisements. Once advertisements are placed, associated users (users whose avatars or portions of VU 48 have been associated with advertisements, and as referred to herein as “advertising users”) can be compensated based on the frequency, time, etc. that associated advertisements are viewed. Such compensation can be in the form of credits associated with the VU being provided to the advertising user(s) and/or a compensation to be provided to the advertising user(s) outside of the VU (e.g., in the real world in the form of money, gift certificates, goods and/or services, etc.).

Along these lines, the advertising user(s) of a VU and/or owners of portions of VU 48 can be compensated (e.g., per click) to serve as walking advertisement(s). In one illustrative scenario, an avatar for the advertising user could wear a garment in the VU with a logo or the like. As such, if another user clicks on the garment, they can be linked, either through teleportation in the VU space or invocation in legacy web browser space, to products, services, or special offers. Alternatively, clicking on the garment could download promotional material to the avatar inventory of the triggering user. In a more subtle scenario, such a logo could be implicit and require an action to unveil (e.g., through a right click and “show sponsor” action). One element of this invention is that the advertising user(s) can choose advertisement(s) that reflect their own tastes and values. This approach combines the best of viral marketing with known pay-per-click methods, and rolls it out in a totally new forum.

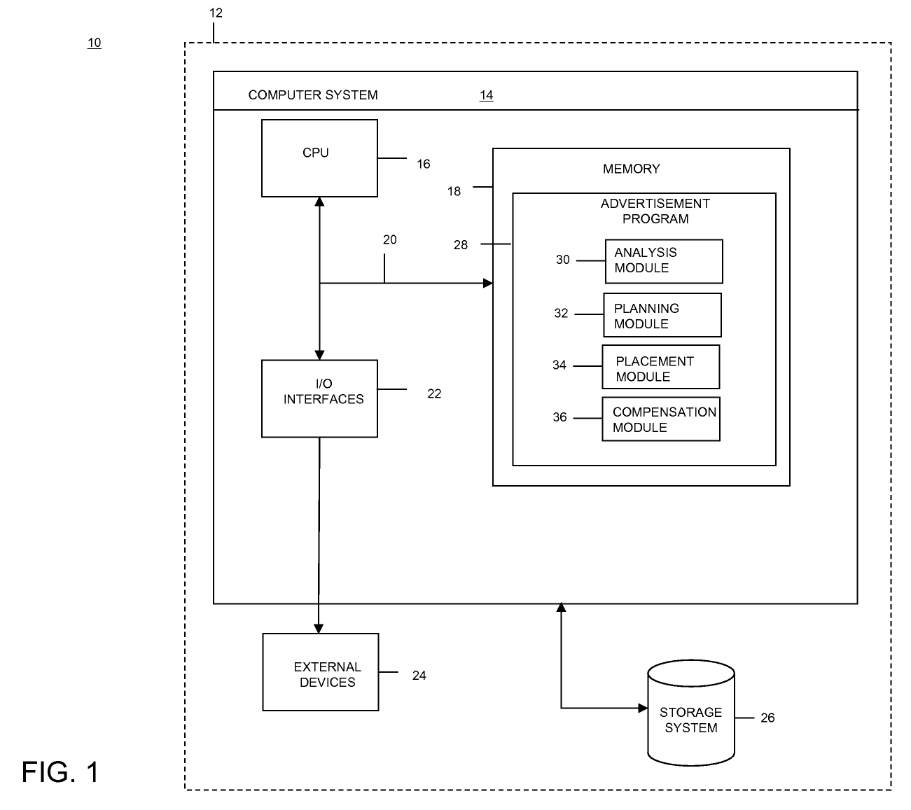

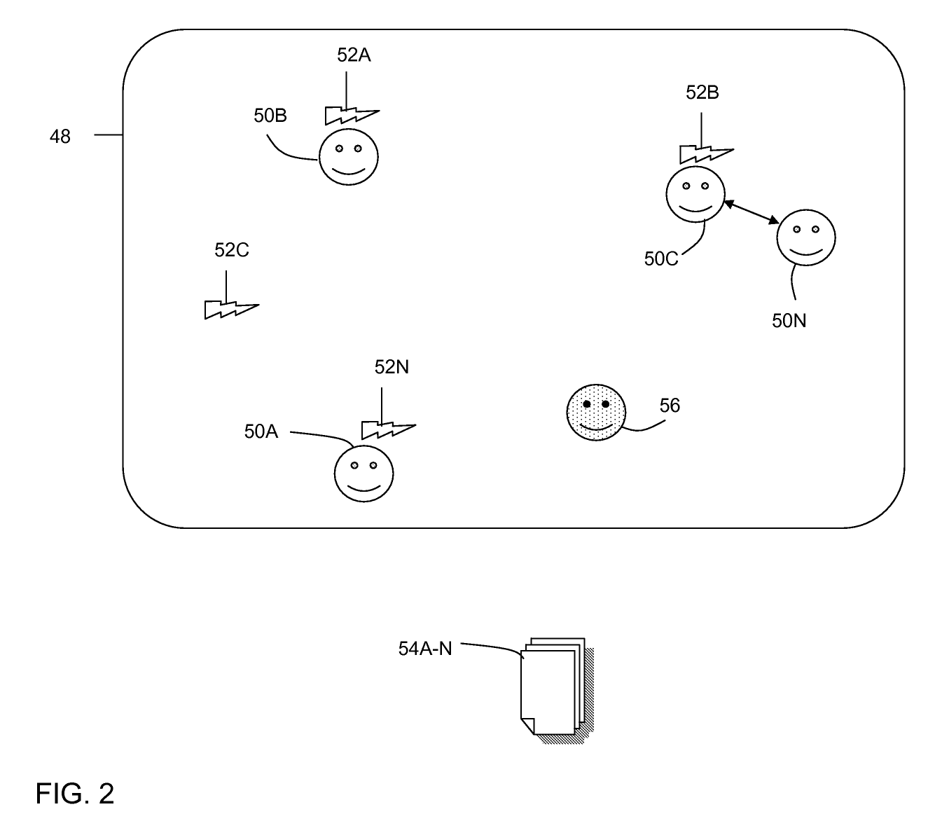

These concepts will be explained in greater detail with respect to FIGS. 1 and 2 collectively. Specifically, FIG. 1 shows a computerized implementation 10 of the present invention to be further described below, while FIG. 2 shows an illustrative VU 48 having avatar(s) 50A-N (corresponding to advertising user(s)). As mentioned above, avatar(s) 50A-N are graphical representations of user(s) that have characteristics (physical and otherwise) based on selections and/or designations made in the user(s)' accounts. Avatar(s) 50A-N navigate about VU 48 and interact with each other, and the environment of VU 48. Advertisement reference(s) 52A-N can represent visual reference(s) to advertisement(s) 54A-N, or visual renderings of the advertisements themselves with which avatar(s) 50A-N have agreed to be associated.

As depicted in FIG. 1, implementation 10 includes computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of implementation 10 could be deployed, managed, serviced, etc. by a service provider who offers to implement, deploy, and/or perform the functions of the present invention for others. As such, an advertiser, a provider of VU 48, or another third party could implement any component shown in FIG. 1. In any event, advertisement program 28 could work in conjunction with any program(s) used to provide and/or manage VU 48.

As shown, computer system 14 includes a processing unit 16, a memory 18, a bus 20, and input/output (I/O) interfaces 22. Further, computer system 14 is shown in communication with external I/O devices/resources 24 and storage system 26. In general, processing unit 16 executes computer program code, such as advertisement program 28, which is stored in memory 18 and/or storage system 26. While executing computer program code, processing unit 16 can read and/or write data to/from memory 18, storage system 26, and/or I/O interfaces 22. Bus 20 provides a communication link between each of the components in computer system 14. External devices 24 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the process(es) of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 16 may comprise a single processing unit, or be distributed across one or more processing units in one or more locations, e.g., on a client and server. Similarly, memory 18 and/or storage system 26 can comprise any combination of various types of data storage and/or transmission media that reside at one or more physical locations. Further, I/O interfaces 22 can comprise any system for exchanging information with one or more external device 24. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 24 (e.g., a display) and/or storage system 26 could be contained within computer system 14, not externally as shown.

Storage system 26 can be any type of system (e.g., a database) capable of providing storage for information under the present invention. To this extent, storage system 26 could include one or more storage devices, such as a magnetic disk drive or an optical disk drive. In another embodiment, storage system 26 includes data distributed across, for example, a local area network (LAN), wide area network (WAN) or a storage area network (SAN) (not shown). In addition, although not shown, additional components, such as cache memory, communication systems, system software, etc., may be incorporated into computer system 14. It should be understood computer system 14 could be maintained by advertisers, a provider of the VU 48, or any third party such as a service provider that could obtain and process information from VU 48 for advertisers.

Shown in memory 18 of computer system 14 is advertisement program 28, which facilitates the functions as described herein. As depicted, advertisement program 28 includes analysis module 30, planning module 32, placement module 34, and compensation module 36. It should be understood that this configuration of functionality is intended to be illustrative only, and that identical or similar functionality could be provided with a different configuration of systems. As mentioned above, it should be understood that advertisement program 28 and/or the teachings recited here could be implemented by a provider of VU 48, by advertisers, or by a third party service provider. When provided by the provider of VU 48, advertisement program 28 could be incorporated within any program(s) used to render and manage VU 48.

In any event, analysis module 30 will first determine which sections of a region (e.g., portions of VU 48) and which avatars 50A-N are most viewed. There are multiple methods that can determine what is being viewed. For example, analysis module 28 could: (1) track the number of texture renderings, for what duration, and at what distances a portion or avatar 50A-N is being viewed; (2) remove or not include data from agents that are discovered or known to be controlled by AI (Artificial Intelligence); (3) discount time something is rendered if it appears the user is not actively at their machine, such as if there is no VU interaction within a set period of time. Additionally, the VU client software, with modifications, can send event information such as when the client window is in the background or when the user's device is locked; and/or (4) receive data from a user eye monitoring device, such as what locations and avatars a user is viewing. Based on this analysis, analysis module 30 can identify the users corresponding to the most viewed avatars and portions as being worthy of a proposed advertisement deal.

In any event, planning module 32 is then configured to use this data to plan a placement of advertisements in VU 48 (e.g., in certain portions and/or in association with certain avatars 50A-N. In a typical embodiment, planning module 32 will use the data as follows:
1. With the aggregate data of the most viewed avatars, it can be known which users to propose advertisement deals with (such as paying a user to have their avatar wear a shirt with a logo on it).
2. With the aggregate data of the most viewed locations, advertisers it can be known where to place advertisements, such as billboards.
3. With the aggregate data of the distance to potential advertising locations, it can be determined how to make the billboard legible. Font size, font type, etc.
4. If the aggregate data is streamed real-time, it can be used to direct to where an AI (artificial intelligence) avatar 56 carrying an advertisement should travel. For example, rather than just direct the avatar to a crowded location, this method allows the automated avatar to hop around to the places in a crowd where more people are currently looking, and can make sure it is seen at least once by all unique agent UUIDs in the crowd.

Based on the planned placement, placement module 32 will place advertisements 54A-N in VU 48 (as indicated by visual references 52A-N). Specifically, placement module will associate advertisements 54A-N/visual references 52A-N in/around the most viewed portions and avatars 50A-N. Along these lines visual references 52A-N can be visual renderings of advertisements themselves 54A-N or objects corresponding to the advertisements 54A-N. Regardless, visual references 52A-N can be optionally distinguished/highlighted from other objects in VU 48 by providing an associated symbol, a glow, a textual display, an audio queue, etc. As can be seen in FIG. 2, not all avatars 50A-N were deemed worth of an advertisement deal. For example, avatar 50N was no associated with an advertisement/visual reference.

As the advertisements 54A-N are viewed, compensation module 36 can establish a compensation plan (for users whose avatars 50A-C have been associated with advertisements, and users or administrators “who” own any portions of VU 48 that have been associated with advertisements, collectively referred to as advertising users). Along these lines, compensation module can employ similar tactics used by analysis module 30 to keep track of how many times an advertisement has been viewed, for what duration, and at what distance, etc. However, in this case, rather than monitoring locations or avatars that are being rendered, compensation module 36 monitors renderings of the advertisement asset itself. This data can then be factored into compensating the user, or ceasing the advertisement relationship.

A new database field can also be added to VU 48 software associated that can keep a tally or calculate a numeric score representing how influential or active an advertising user is at advertising. To prevent abuse (given typically anyone can advertise, and therefore establish fake advertisement schemes), the present invention can designate certified corporations as the only advertisements that will have weight in the score. For example, the score can be derived from how much VU or real world compensation has been paid to advertising users by advertisers who have registered paid advertisement agreements with the VU owners. This score can be used by future advertisers to determine who to tap to display an advertisement, and can be used by users to try to negotiate a higher payment plan.

Reiterating, a software abstraction level may calculate for an advertisement, product placement, or spot considered, for one or more of the following criteria:

how many distinct users/avatars have viewed the advertisement;

how many seconds, minutes, or hours the advertisement has been viewed;

how many users/avatars observed the advertisement with its resolution/size beyond a certain minimum threshold;

once such information is available, what are the demographics of the users who viewed the advertisement; and/or

which of the avatars viewing the advertisement or product placement are artificial intelligence entities and which are human controlled?

Along these lines, to prevent abuse of rogue avatars who wish to unduly influence the identifying of portions of the VU and avatars in the VU that are most viewed, professional viewing avatars who are trusted to effectively carrying out the viewing tasks may be implemented and/or used by compensation module 36. Considering the above factors allows advertisements to be directed with the highest possible efficiencies. Regardless, compensation module 36 can cause advertising users 50A-C to be compensated. This can be in any way now known or later developed. One example is that the advertising user(s) can be compensated on a “per click” per-click based on invocation of advertisement(s) 54A-N and/or execution of the corresponding action(s). Another example is that the advertising users 50A-C can be compensated just for allowing association with advertisements(s) 54A-N. Yet another is that the advertising user 50A-C can be compensated based on completion of transaction(s) between user viewing the advertisements 54A-N and merchant(s) associated with advertisement 54A-N. Regardless of the compensation method, such compensation can take any form such as the advertising user 50A-C being provided with credit associated with VU 48, provided with compensation outside of VU 48 in the “real world” with compensation such as such as money, gift certificate(s), good(s) and/or service(s), etc.

While shown and described herein as a method and system for planning and paying for advertisements in a VU, it is understood that the invention further provides various alternative embodiments. For example, in one embodiment, the invention provides a computer-readable/useable medium that includes computer program code to enable a computer infrastructure to plan and pay for advertisements in a VU. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 18 (FIG. 1) and/or storage system 26 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to plan and pay for advertisements in a VU. In this case, the service provider can create, maintain, support, etc., a computer infrastructure, such as computer infrastructure 12 (FIG. 1) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for planning and paying for advertisements in a VU. In this case, a computer infrastructure, such as computer infrastructure 12 (FIG. 1), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method of planning and paying for advertisements in a virtual universe (VU), comprising:
identifying portions of the VU and avatars in the VU that are most viewed;
planning a placement of advertisements in the VU based on the identifying; and
establishing a compensation plan based on a viewing of the advertisements.

2. The method of claim 1, the identifying comprising tracking a quantity of texture renderings, a duration, and a distance that each portion and avatar in the VU is being viewed.

3. The method of claim 1, the planning comprising at least one of the following:
identifying users corresponding to the most viewed avatars and portions for proposed advertisement deals;
identifying locations in the VU for placement of advertisements; and
determining an appropriate size of the advertisements.

4. The method of claim 1, the compensation plan being based on at least one of the following:
a quantity of times each of the advertisements has been viewed;
a duration that each of the advertisements has been viewed;
a distance from which each of the advertisements has been viewed; and
a quantity of users that have viewed each of the advertisements.

5. The method of claim 1, further comprising placing advertisements in the VU based on the planning.

6. The method of claim 5, the placing comprising at least one of the following:
associating advertisements with the most viewed avatars; and
associating advertisements with the most viewed portions of the VU.

7. The method of claim 1, the compensation plan comprising at least one of the following:
a provision of credits associated with the VU; and
a provision of compensation outside of the VU.

8. A system of planning and paying for advertisements in a virtual universe (VU), comprising:
a module for identifying portions of the VU and avatars in the VU that are most viewed;
a module for planning a placement of advertisements in the VU based on the portions and the avatars;
a module for placing the advertisements based o the placement; and
a module for establishing a compensation plan based on a viewing of the advertisements.

9. The system of claim 8, the module for identifying being configured to track a quantity of texture renderings, a duration, and a distance that each portion and avatar in the VU is being viewed.

10. The system of claim 8, the module for planning being configured to:
identifying users corresponding to the most viewed avatars and portions for proposed advertisement deals;
identifying locations in the VU for placement of advertisements; and
determining an appropriate size of the advertisements.

11. The system of claim 8, the compensation plan being based on at least one of the following:
a quantity of times each of the advertisements has been viewed;
a duration that each of the advertisements has been viewed;
a distance from which each of the advertisements has been viewed; and
a quantity of users that have viewed each of the advertisements.

12. The system of claim 8, the module for placing being configured to:
associate advertisements with the most viewed avatars; and
associate advertisements with the most viewed portions of the VU.

13. The system of claim 8, the compensation plan comprising at least one of the following:
a provision of credits associated with the VU; and
a provision of compensation outside of the VU.

14. A program product stored on a computer readable medium for planning and paying for advertisements in a virtual universe (VU), the computer readable medium comprising program code for causing a computer system to:
identify portions of the VU and avatars in the VU that are most viewed;
plan a placement of advertisements in the VU based on the portions and the avatars; and
establish a compensation plan based on a viewing of the advertisements.

15. The program product of claim 14, the computer readable medium further comprising program code for causing the computer system to track a quantity of texture renderings, a duration, and a distance that each portion and avatar in the VU is being viewed.

16. The program product of claim 14, the computer readable medium further comprising program code for causing the computer system to:
identifying users corresponding to the most viewed avatars and portions for proposed advertisement deals;
identifying locations in the VU for placement of advertisements; and
determining an appropriate size of the advertisements.

17. The program product of claim 14, the compensation plan being based on at least one of the following:
a quantity of times each of the advertisements has been viewed;
a duration that each of the advertisements has been viewed;
a distance from which each of the advertisements has been viewed; and
a quantity of users that have viewed each of the advertisements.

18. The program product of claim 14, the computer readable medium further comprising program code for causing the computer system to place advertisements in the VU based on the placement.

19. The program product of claim 18, the computer readable medium further comprising program code for causing the computer system to:
associate advertisements with the most viewed avatars; and
associate advertisements with the most viewed portions of the VU.

20. The program product of claim 14, the compensation plan comprising at least one of the following:
a provision of credits associated with the VU; and
a provision of compensation outside of the VU.

21. A method for deploying a system for planning and paying for advertisements in a virtual universe (VU), comprising:
providing a computer infrastructure being operable to:
identify portions of the VU and avatars in the VU that are most viewed;
plan a placement of advertisements in the VU based on the portions and the avatars; and
establish a compensation plan based on a viewing of the advertisements.
